(19) United States
(12) Patent Application Publication
(10) Pub. No.: US 2012/0165144 A1
(43) Pub. Date: Jun. 28, 2012

(54) CHAIN GUIDE PLATE

(75) Inventors: Nicolas Dogimont, Marny Les Compiegne (FR); Christian Poiret, Coulogne (FR)

(73) Assignee: SCHAEFFLER TECHNOLOGIES GMBH & CO. KG, Herzogenaurach (DE)

(21) Appl. No.: 13/146,351

(22) PCT Filed: Dec. 2, 2009
(86) PCT No.: PCT/EP2009/066193

§ 371 Date: Jan. 4, 2012

(30) Foreign Application Priority Data
Jan. 27, 2009 (DE) 10 2009 006 244.0

(51) Int. Cl. F16G 13/04; F16G 13/02

(52) U.S. Cl. 474/212; 474/206

(57) ABSTRACT

The invention relates to a chain guide plate, more particularly a chain guide side plate, having a contour profile (1) which has at least one contour profile section (3) of concave configuration and at least one contour profile section (7) of convex configuration situated opposite the contour profile section (3) of concave configuration. An area (22) formed by the contour profile section (7) of convex configuration can be arranged within an area (21) formed by the contour profile section (3) of concave configuration.

### FIELD OF THE INVENTION

The invention relates to a chain guide plate, more particularly a chain guide side plate, having a contour profile which has at least one contour profile section of concave configuration and at least one contour profile section of convex configuration situated opposite the contour profile section of concave configuration.

### BACKGROUND

US 2003/0181274 A1 has already disclosed a chain guide plate with a contour profile which has at least one contour profile section of concave configuration and at least one contour profile section of convex configuration situated opposite the contour profile section of concave configuration. A chain guide plate of this kind is used especially for guiding a chain link on a chain sprocket.

### SUMMARY

It is the underlying object of the invention, in particular, to provide an improved chain guide plate by means of which it is possible to achieve a low-wear chain link. This is achieved according to the invention. Further embodiments will emerge from the subclaims and the additional independent claim.

The invention takes as its starting point a chain guide plate, more particularly a chain guide side plate, having a contour profile which has at least one contour profile section of concave configuration and at least one contour profile section of convex configuration situated opposite the contour profile section of concave configuration.

It is provided that an area formed by the contour profile section of convex configuration can be arranged within an area formed by the contour profile section of concave configuration. This makes it possible to arrange two chain guide plates directly adjacent to one another during a punching operation, for example, thereby making it possible to achieve a particularly advantageous chain guide plate since it is possible, in particular, to save on the costs of materials for the chain guide plate. Moreover, this makes it possible to optimize the stiffness of the chain guide plate, thereby making it possible to achieve a particularly low-wear chain link.

A contour profile section of “concave” configuration is intended to refer, in particular, to a contour profile section in which a straight line connecting a starting point and an end point of the contour profile section extends completely outside a component forming the contour profile section. In principle, a contour profile section of concave configuration can also have convexly curved and/or rectilinear contour profile subsections. A contour profile section of “convex” configuration is intended to refer, in particular, to a contour profile section in which a straight line connecting a starting point and an end point of the contour profile section extends completely within a component forming the contour profile section. In principle, a contour profile section of convex configuration can also have concavely curved and/or rectilinear contour profile subsections.

A “contour profile section” is intended to refer, in particular, to a section of a contour profile which has at least one contour profile subsection with a length of at least 5% of the total contour profile, a length of at least 10% being advantageous and of at least 15% being particularly advantageous.

A “chain guide plate” is intended to refer, in particular, to a chain plate of a chain link which is provided exclusively for lateral guidance and for transmission of tensile forces along a main direction of extension of the chain link. In particular, it is intended to refer to a chain plate in the chain link which is not provided for positive coupling to a chain sprocket or some other suitable drive means for transmitting drive torques.

It is furthermore provided that the chain guide plate comprises an outside contour profile which has a contour profile section of concave configuration. This makes it possible to optimize the stiffness of the chain guide plate in an advantageous manner. An “outside contour profile” is furthermore intended to refer, in particular, to a contour profile which is oriented towards the outside relative to an envisaged arrangement of the chain guide plate on a chain sprocket or a similar component provided for coupling to the chain guide plate.

It is furthermore provided that the chain guide plate comprise an inside contour profile which has the contour profile section of convex configuration. This makes it possible to achieve an advantageous chain guide plate. An “inside contour profile” is furthermore intended to refer, in particular, to a contour profile which is situated opposite the outside contour profile, i.e. is oriented towards the inside relative to an envisaged arrangement of the chain guide plate on the chain sprocket or the similar component provided for coupling to the chain guide plate.

The contour profile section of convex configuration and the contour profile section of concave configuration are advantageously configured in such a way as to correspond. This makes it a simple matter to arrange the area formed by the contour profile section of convex configuration within the area formed by the contour profile section of concave configuration. “Contour profile subsections configured in such a way as to correspond” are intended to refer, in particular, to two contour profile subsections that correspond in respect of the curvature profile thereof.

In particular, it is provided that the contour profile section of convex configuration and the contour profile section of concave configuration have contour line profiles of substantially congruent configuration. This makes it possible to achieve two contour profile subsections that correspond particularly well. A “contour line profile” is intended to refer, in particular, to a profile of a contour line of the contour profile subsection which is independent of the extent of the chain guide plate relative to the contour profile subsection, e.g. a contour profile section of concave configuration and a contour subsection of convex configuration with a curvature of equal magnitude. In particular, “contour line profiles configured in such a way as to be congruent” are intended to refer to two contour line profiles which, when projected one onto the other, have a substantially identical profile.

It is furthermore provided that the contour profile section of concave configuration has at least one central contour profile subsection which is concavely curved. This makes it possible to optimize the stiffness of the guide element in a particularly advantageous manner since it is thereby possible to reduce the stiffness relative to a chain guide plate with a rectilinear contour profile. A “central contour profile subsection” is intended to refer, in particular, to a contour profile subsection adjoined on both sides by at least one further contour profile subsection of the contour profile section which deviates from a concave configuration.

It is furthermore provided that the chain guide plate have a guide element which is formed by means of the contour profile section of convex configuration and is provided for lateral guidance. This makes it possible to achieve particularly advantageous guidance.

The contour profile section of convex configuration advantageously has at least one central contour profile subsection which is convexly curved. This is a particularly advantageous way of reducing the stiffness of the chain guide plate, thereby making it possible to increase loading for further chain plates connected to the chain guide plate and thus improve loading of individual chain plates of a chain link.

The contour profile is advantageously convexly/concavely/convexly curved in at least three adjoining contour profile subsections. This makes it possible to provide a particularly advantageous contour profile section of concave configuration.

It is furthermore provided that the contour profile be concavely/convexly/concavely curved in at least three adjoining contour profile subsections. This makes it possible to provide a particularly advantageous contour profile section of convex configuration.

The invention furthermore provides an inverted tooth chain link having at least one chain force transmission plate for drive coupling and having at least one chain guide plate, in particular an outer chain guide plate which has a contour profile with at least one contour profile section of concave configuration and at least one contour profile section of convex configuration situated opposite the contour profile section of concave configuration, wherein an area formed by the contour profile section of convex configuration can be arranged within an area formed by the contour profile section of concave configuration. This makes it possible to provide a chain link which has a particularly advantageous load distribution between the chain links. Here, “inverted tooth chain link” is intended to refer, in particular, to a chain link of an inverted tooth chain.

The chain guide plate is advantageously arranged as an outer chain plate. This makes it possible to obtain a particularly advantageous arrangement for the chain guide plate. Here, “outer chain plate” is intended to refer, in particular, to a chain plate which is arranged on the outside relative to a transverse direction of the chain link.

It is furthermore provided that the chain force transmission plate be designed as a toothed chain plate. This makes it possible to provide a particularly advantageous chain link. In principle, however, it is also possible to form other chain links by means of the chain guide plate and a corresponding chain force transmission plate, e.g. a chain link of a roller chain, a chain link of a bush chain and/or a chain link of a sleeve-type chain.

Further advantages will emerge from the following description of the drawings. The drawings, the description and the claims contain numerous features in combination. A person skilled in the art would also considers the features individually and put them together to form worthwhile further combinations.

### BRIEF DESCRIPTION OF THE DRAWINGS

An exemplary embodiment of the invention is depicted in the drawings and described in greater detail below. In the drawings:

FIG. 1 shows a chain link having two chain guide plates according to the invention;

FIG. 2 shows one of the chain guide plates in a perspective representation;

FIG. 3 shows an arrangement of the chain link on a chain sprocket;

FIG. 4 shows a chain force transmission plate of the chain link in a side view;

FIG. 5 shows the chain guide plate from FIG. 2 in a side view;

FIG. 6 shows a load distribution on the chain force transmission plates and the chain guide plates when a load is imposed on the chain link.

### DETAILED DESCRIPTION OF THE PREFERRED EMBODIMENTS

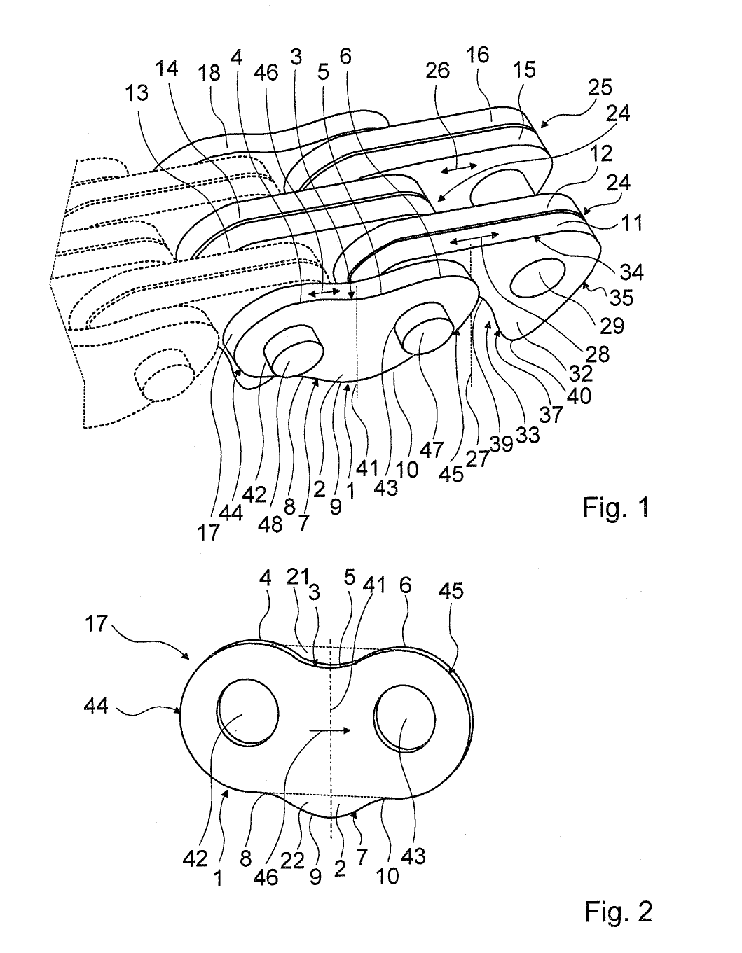

FIG. 1 shows a chain link which is designed as an inverted tooth chain link. The chain link is provided for transmitting a drive torque. The chain link is provided for positive coupling to a chain sprocket 19. At an outer circumference, the chain sprocket 19 has a tooth system 20, which is provided for engagement with the chain link.

For guidance on the chain sprocket 19, the chain link has two chain guide plates 17, 18. For positive connection to the chain sprocket 19, the chain link has six chain force transmission plates 11, 12, 13, 14, 15, 16. The chain guide plates 17, 18 and the chain force transmission plates 11, 12, 13, 14, 15, 16 are connected to one another by means of a hinge pin 47. Another chain link of similar configuration is connected to the chain link by means of a second hinge pin 48. The additional chain link is depicted in dashed lines in FIG. 1 to provide a better illustration.

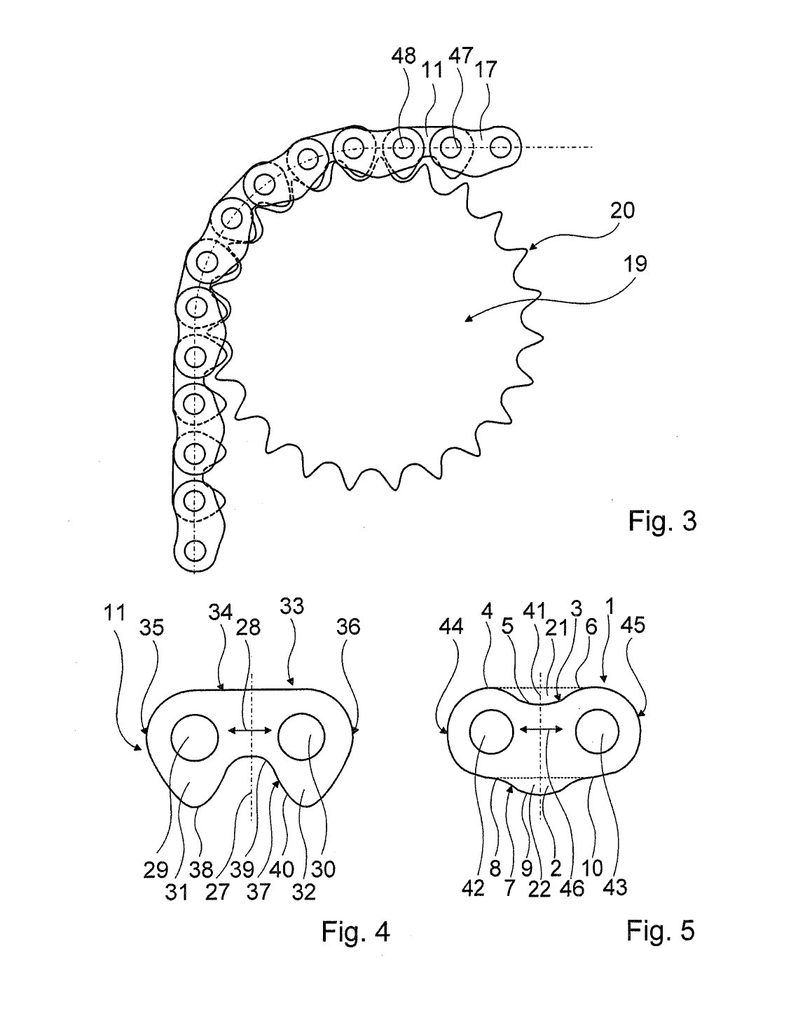

The chain guide plates 17, 18 are arranged as outer chain plates. The chain link is guided laterally by means of the chain guide plates 17, 18. To guide the chain link on the chain sprocket 19, the chain guide plates 17, 18 are arranged laterally with respect to the chain sprocket 19 (see FIG. 3). Lateral flanks of the chain guide plates 17, 18 are provided for positive coupling to the chain sprocket 19.

The chain force transmission plates 11, 12, 13, 14, 15, 16 are each arranged in pairs. The two chain force transmission plates 11, 12 and the two chain force transmission plates 15, 16 each form an inner chain plate pair 23, 25. The two chain force transmission plates 13, 14 form a central chain plate pair 24. The chain force transmission plates 11, 12, 15, 16 of the inner chain plate pairs 23, 25 and the chain force transmission plates 13, 14 of the central chain plate pair 24 are arranged offset relative to one another along a main direction 26 of extension of the chain link. The chain guide plates 17, 18 and the chain force transmission plates 13, 14 of the central chain plate pair 24 are arranged at the same level along the main direction 26 of extension of the chain link.

All the chain force transmission plates 11, 12, 13, 14, 15, 16 are of similar design. The following description of chain force transmission plate 11 can thus be applied to the other chain force transmission plates 12, 13, 14, 15, 16.

Chain force transmission plate 11 is of symmetrical design with respect to a center line 27 (cf. FIG. 4). The center line 27 is oriented perpendicularly to a main direction 28 of extension of chain force transmission plate 11. For connection by means of the hinge pins 47, 48, the chain force transmission plate 11 has two hinge pin holes 29, 30, through which the hinge pins 47, 48 are passed in the assembled state. For engagement in the tooth system 20 of the chain sprocket 19, chain force transmission plate 11 has two teeth 31, 32. The teeth 31, 32 are formed by means of a contour profile 33 of chain force transmission plate 11. Perpendicularly to the main direction 28 of extension of chain force transmission plate 11, one of the hinge pin holes 29, 30 and one of the teeth 31, 32, respectively, are arranged at the same level.

The contour profile 33 of chain force transmission plate 11 has an outside contour profile 34 which is arranged on a side of chain force transmission plate 11 facing away from the teeth 31, 32. The outside contour profile 34 delimits chain force transmission plate 11 on the outside with respect to the chain sprocket 19. The outside contour profile 34 is of rectilinear design. It extends parallel to the main direction 28 of extension.

The contour profile 33 of chain force transmission plate 11 furthermore has two longitudinal-side contour profiles 35, 36, which delimit chain force transmission plate 11 along the main direction 28 of extension. The longitudinal-side contour profiles 35, 36 are of approximately circular design. The longitudinal-side contour profiles 35, 36 have a center which coincides with a center of the hinge pin holes 29, 30. The outside contour profile 34 and the longitudinal-side contour profiles 35, 36 merge tangentially into one another. Chain force transmission plate 11 is of convex design over the entire range of the outside contour profile 34 and of the longitudinal-side contour profiles 35, 36.

The contour profile 33 of chain force transmission plate 11 furthermore has an inside contour profile 37, which delimits chain force transmission plate 11 on the inside. The inside contour profile 37 has a central contour profile subsection 39 of concave design. Two outer contour profile subsections 38, 40 of the inside contour profile 37 which adjoin the central contour profile subsection 39 are of convex design. The teeth 31, 32 of chain force transmission plate 11 are formed by means of the two outer contour profile subsections 38, 40. Chain force transmission plate 11 is of alternately convex, concave and convex design in the region of the inside contour profile 37, i.e. in the three contour profile subsections 38, 39, 40.

The two chain guide plates 17, 18 are likewise of similar design. The following description of chain guide plate 17 can thus be applied to the other chain guide plate 18.

Chain guide plate 17 is of symmetrical design with respect to a center line 41 (cf. FIG. 5). For connection by means of the hinge pins 47, 48, chain guide plate 17 likewise has two hinge pin holes 42, 43, through which the hinge pins 47, 48 are passed in the assembled state. For lateral guidance, chain guide plate 17 has a guide element 2, which is arranged in a central region of chain guide plate 17. The guide element 2 of chain guide plate 17 is formed by means of a contour profile 1 of chain guide plate 17.

When the chain link engages in the chain sprocket 19, the guide element 2 of chain guide plate 17 is arranged laterally with respect to the tooth system 20 of the chain sprocket 19. As a result, the chain sprocket 19 and the guide element 2 are connected positively to one another for lateral displacement of the chain link on the chain sprocket 19.

The contour profile 1 of chain guide plate 17 has a contour profile section 3 of concave configuration, which is arranged on a side of chain guide plate 17 facing away from the guide element 2 and which is designed as an outside contour profile. The contour profile section 3 of concave configuration delimits chain guide plate 17 on the outside with respect to the chain sprocket 19. The contour profile section 3 of concave configuration has a central contour profile subsection 5 which is of concavely curved design. Two outer contour profile subsections 4, 6 of the contour profile section 3 of concave configuration which adjoin the central contour profile subsection 5 are of convexly curved design. Chain guide plate 17 is of alternately convex, concave and convex design in the region of the contour profile section 3 of concave configuration, i.e. in the three contour profile subsections 4, 5, 6.

The contour profile 1 of chain guide plate 17 furthermore has two longitudinal-side contour profiles 44, 45, which delimit chain guide plate 17 along a main direction 46 of extension of chain guide plate 17. The two longitudinal-side contour profiles 44, 45 are convexly curved. They are of approximately circular design. The longitudinal-side contour profiles 44, 45 each have a center which coincides with a center of the hinge pin holes 42, 43. The hinge pin holes 42, 43 are arranged partially in an area formed by the longitudinal-side contour profiles 44, 45. The contour profile section 3 of concave configuration and the longitudinal-side contour profiles 44, 45 merge tangentially into one another.

Moreover, the contour profile 1 of chain guide plate 17 has a contour profile section 7 of convex configuration, which delimits chain guide plate 17 on the inside and is designed as an inside contour profile. The guide element 2 for guidance on the chain sprocket 19 is formed by means of the contour profile section 7 of convex configuration. The contour profile section 7 of convex configuration and the contour profile section 3 of concave configuration are formed on opposite sides of chain guide plate 17. The contour profile section 7 of convex configuration and the longitudinal-side contour profiles 44, 45 merge tangentially into one another.

The contour profile section 7 of convex configuration has a central contour profile subsection 9, which is concavely curved. The central contour profile subsection 9 forms the guide element 2. An area formed by the central contour profile subsection 9 is provided for contact with the chain sprocket 19. Two outer contour profile subsections 8, 10 of the contour profile section 7 of convex configuration which adjoin the central contour profile subsection 9 on both sides are shaped with a concave curvature. Chain guide plate 17 is of alternately concave, convex and concave design in the region of the contour profile section 7 of convex configuration, i.e. in the three contour profile subsections 8, 9, 10.

The contour profile section 3 of concave configuration forms an area 21 which is designed as a recess in chain guide plate 17 relative to a rectilinear design. The contour profile section 7 of convex configuration forms an area 22 which is designed as a projection relative to a rectilinear design. The area 21 formed by the contour profile section 3 of concave configuration can be arranged completely within the area 22 formed by the contour profile section 7 of convex configuration (cf. FIG. 4).

The contour profile section 7 of convex configuration and the contour profile section 3 of concave configuration are designed in such a way as to correspond to one another (cf. FIG. 2). The contour profile subsections 4, 5, 6 of the contour profile section 3 of concave configuration and the contour profile subsections 8, 9, 10 of the contour profile section 7 of convex configuration are designed in such a way as to be congruent. A contour line of the contour profile subsections 4, 5, 6 of the contour profile section 3 of concave configuration and a contour line of the contour profile subsections 8, 9, 10 of the contour profile section 7 of convex configuration have a substantially identical profile. A curvature of contour profile subsections 4, 8, contour profile subsections 5, 9 and contour profile subsections 6, 10 is in each case equal in magnitude at a distance from the center line 41.

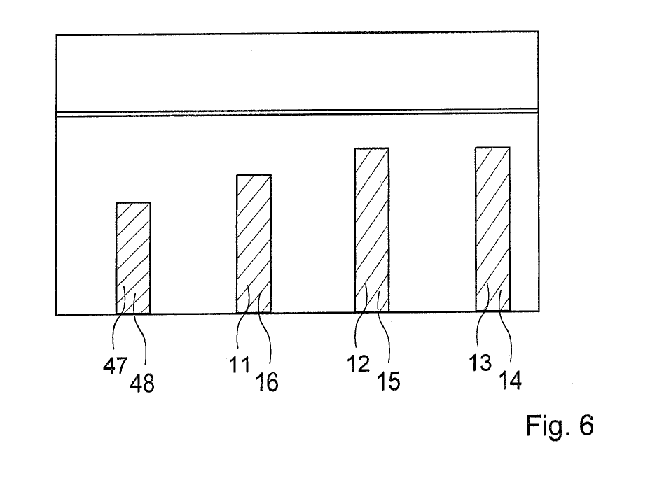

By means of the contour profile section 3 of concave configuration, which can in principle also be configured independently of the contour profile section 7 of convex configuration, a tensile stiffness of chain guide plate 17 along the main direction 46 of extension of chain guide plate 17 can be matched to a tensile stiffness of the chain force transmission plates 11, 12, 13, 14, 15, 16. Similarly, a tensile stiffness of chain guide plate 17 is matched to the tensile stiffness of the chain force transmission plates 11, 12, 13, 14, 15, 16. When a load is imposed on the chain link, a load imposed on the chain force transmission plates 11, 12 and chain force transmission plates 15, 16 of the two inner chain plate pairs 23, 25 is approximately equal. A load imposed on the chain force transmission plates 13, 14 of the central chain plate pair 24 is approximately equal to the load imposed on the chain force transmission plates 11, 12, 15, 16 of chain plate pairs 23, 25. A difference between the loads imposed on the chain force transmission plates 11, 12, 13, 14, 15, 16 is at most 25% of the minimum load imposed. Chain force transmission plates 11, 16 are subject to the smallest load, while chain force transmission plates 12, 15 and chain force transmission plates 13, 14 are subject to the same load. Loads imposed on the hinge pins 47, 48 are about 80% of the loads imposed on the chain force transmission plates 11, 16 (cf. FIG. 6).

List of Reference Signs
1 Contour Profile
2 Guide Element
3 Contour Profile Section
4 Contour Profile Subsection
5 Contour Profile Subsection
6 Contour Profile Subsection
7 Contour Profile Section
8 Contour Profile Subsection
9 Contour Profile Subsection
10 Contour Profile Subsection
11 Chain Force Transmission Plate
12 Chain Force Transmission Plate
13 Chain Force Transmission Plate
14 Chain Force Transmission Plate
15 Chain Force Transmission Plate
16 Chain Force Transmission Plate
17 Chain Guide Plate
18 Chain Guide Plate
19 Chain Sprocket
20 Tooth System
21 Area
22 Area
23 Chain Plate Pair
24 Chain Plate Pair
25 Chain Plate Pair
26 Main Direction of Extension
27 Center Line
28 Main Direction of Extension
29 Hinge Pin Hole
30 Hinge Pin Hole
31 Tooth
32 Tooth
33 Contour Profile
34 Outside Contour Profile
35 Longitudinal-side Contour Profile
36 Longitudinal-side Contour Profile
37 Inside Contour Profile
38 Contour Profile Subsection
39 Contour Profile Subsection
40 Contour Profile Subsection
41 Center Line
42 Hinge Pin Hole
43 Hinge Pin Hole
44 Longitudinal-side Contour Profile
45 Longitudinal-side Contour Profile
46 Main Direction of Extension
47 Hinge Pin
48 Hinge Pin

1. A chain guide plate, comprising a plate having a contour profile which has at least one contour profile section of concave configuration and at least one contour profile section of convex configuration situated opposite the contour profile section of concave configuration, and an area formed by the contour profile section of convex configuration can be arranged within an area formed by the contour profile section of concave configuration.

2. The chain guide plate according to claim 1, the plate further comprising an outside contour profile which has the contour profile section of concave configuration.

3. The chain guide plate according to claim 2, the plate further comprising an inside contour profile which has the contour profile section of convex configuration.

4. The chain guide plate according to claim 3, wherein the contour profile section of convex configuration and the contour profile section of concave configuration are configured in such a way as to correspond.

5. The chain guide plate according to claim 4, wherein the contour profile section of convex configuration and the contour profile section of concave configuration have contour line profiles of substantially congruent configuration.

6. The chain guide plate according to claim 4, wherein the contour profile section of concave configuration has at least one central contour profile subsection which is concavely curved.

7. The chain guide plate according to claim 1, wherein a guide element which is formed by of the contour profile section of convex configuration and is provided for lateral guidance.

8. The chain guide plate according to claim 7, wherein the contour profile section of convex configuration has at least one central contour profile subsection which is convexly curved.

9. The chain guide plate according to claim 8, wherein the contour profile is convexly/concavely/convexly curved in at least three adjoining contour profile subsections.

10. The chain guide plate according to claim 8, wherein the contour profile is concavely/convexly/concavely curved in at least three adjoining contour profile subsections.

11. An inverted tooth chain link, comprising at least one chain force transmission plate for drive coupling and having at least one chain guide plate, the at least one chain guide plate comprising a plate having a contour profile which has at least one contour profile section of concave configuration and at least one contour profile section of convex configuration situated opposite the contour profile section of concave configuration, and an area formed by the contour profile section of convex configuration can be arranged within an area formed by the contour profile section of concave configuration.

12. The inverted tooth chain link according to claim 11, wherein the chain guide plate is arranged as an outer chain plate.

13. The inverted tooth chain link according to claim 11, wherein the chain force transmission plate is designed as a toothed chain plate.
